(19) United States
(12) Patent Application Publication
(10) Pub. No.: US 2024/0423247 A1
(43) Pub. Date: Dec. 26, 2024

(54) FENUGREEK NUTRITIONAL SUPPLEMENT COMPOSITIONS

(71) Applicants: David Sandler, Lakewood, CO (US); Peter Scalise, Oakdale, NY (US)

(72) Inventors: David Sandler, Lakewood, CO (US); Peter Scalise, Oakdale, NY (US)

(21) Appl. No.: 18/753,978

(22) Filed: Jun. 25, 2024

Related U.S. Application Data
(60) Provisional application No. 63/510,133, filed on Jun. 25, 2023.

(51) Int. Cl. A23L 2/56; A23L 2/38; A23L 2/39; A23L 2/40

(52) U.S. Cl. CPC A23L 2/56; A23L 2/38; A23L 2/39; A23L 2/40

(57) ABSTRACT

Compositions containing fenugreek and other bioactive ingredients are combined with effective masking agents to prepare a liquid beverage having a palatable flavor. Vitamins minerals, extracts and other bioactive ingredients may be added to further enhance the properties of the nutritional supplement composition. The masking agents include glycyrrhizzic acid, citric acid, malic acid, as well as other sweeteners and flavoring agents. The synergistic interactions between the flavoring agents and the active ingredients including fenugreek eliminate the unpleasant taste generally associated with fenugreek without denigrating its positive benefits.

### BACKGROUND OF THE INVENTION

### Field of the Invention

The present invention relates to a nutritional supplement containing fenugreek. More particularly, the invention relates to a composition including fenugreek mixed with variants agents that effectively mask the unpleasant taste and smell of fenugreek.

### Description of the Related Art

Trigonella foenum-graecum, commonly referred to as Fenugreek, has been cultivated for thousands of years, making it one of the oldest medicinal herbs. Traces of it have been found in Bronze Age tombs, including that of Tutankhamen. It is found in southeastern Europe, northern Africa, and western Asia, although it is widely cultivated in other parts of the world. Fenugreek is a legume which typically grows between two to three feet tall with light green leaves and small white flowers. A Fenugreek seed pod may contain between ten to twenty small, flat, yellow-brown seeds. Typically, a plant seed is formed having a thick or hard outer coat called a testa and often referred to as a seed coat.

Fenugreek has long been used as a medicinal herb and culinary additive in both Asia and the Mediterranean. The Fenugreek plant contains many bioactive compounds, including, for example, iron, vitamins A, B, and C, flavonoids, saponins, and alkaloids. In traditional Asian medicine, Fenugreek has been used to treat abdominal ailments, dysmennorhea, inflammation, to stimulate milk production, and a variety of other conditions. More recently, scientific research has identified numerous bioactive compounds in Fenugreek, and studies into their physiological effects are ongoing.

However, using Fenugreek seeds as a raw material source for a nutritional supplement presents some difficulties. Fenugreek has a strong, bitter taste that is unappealing. Patients or consumers are often unwilling to incorporate adequate quantities of Fenugreek into their diet due to its adverse taste. For this reason, much of the current research into Fenugreek is focused on identify specific compounds found within Fenugreek and means of isolating them from the other compounds responsible for the undesirable taste. This has so far proven difficult.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide a composition containing fenugreek that does not have an undesirable taste.

### BRIEF SUMMARY OF THE INVENTION

Disclosed are compositions for nutritional supplements for providing energy and improving overall health that includes bioactive ingredients known to have a very unpleasing flavor. The compositions of the invention utilize a flavoring system configured to effectively mask the unpleasing flavors of the bioactive ingredients to provide a liquid formulation of the nutritional supplement which has a pleasing flavor.

In one embodiment, the nutritional supplement composition comprises a plurality of bioactive ingredients including niacin, pyridoxine HCL, methylcobalamin, citrulline, arginine, fenugreek, maca root, panax ginseng, caffeine, magnesium, mucuna pruriens, γ-aminobutyric acid, zinc and vitamin D. It also includes a plurality of flavoring system ingredients including citric acid, malic acid, sucralose, vinegar, disodium phosphate, potassium phosphate, sodium gluconate, glycrhizzic acid, ginger powder, vanilla, and orange, and optionally includes one or more of tongkat ali, diindolylmethane, horny goat weed, ashwagandha and coco.

It is therefore an object of the present invention to provide a nutritional supplement composition for liquid consumption including fenugreek and having a pleasing taste.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

In the following description, for purposes of explanation, numerous specific details are set forth in order to provide a thorough understanding of the various embodiments of the subject disclosure. It may be evident, however, that the disclosed subject matter may be practiced without these specific details. Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

Unless otherwise indicated, all numbers expressing quantities of ingredients, dimensions, reaction conditions and so forth used in the specification and claims are to be understood as being modified in all instances by the term “about”. The term “a” or “an” as used herein means “at least one” unless specified otherwise. In this specification and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise. In the tables below, exemplary amounts of various components of the composition are intended as examples suitable for use with the present invention. In general, each of the ingredients may be used within the given range and adjusted as desired. The ingredients of the flavor system in general will require adjustment depending on changes in amounts of the bioactive ingredients.

Various embodiments of the disclosure could also include permutations of the various elements recited in the claims as if each dependent claim was a multiple dependent claim incorporating the limitations of each of the preceding dependent claims as well as the independent claims. That is, the combinations of the various components of the invention are not limited to those combinations expressly shown in the Figures. Unless expressly stated otherwise, components described in one embodiment may be interchanged with components of the same name found in other embodiments. Such permutations are expressly within the scope of this disclosure.

Disclosed are compositions containing fenugreek and synergistic additives and congeners mixed with masking agents that overcome the undesirable and/or astringents tastes and aromas of the bioactive ingredients, such as fenugreek, maca root, arginine and ashwagandha. The compositions may be provided in a powder form and are intended for use in preparing potable liquid drinks. The compositions disclosed herein improve sexual health, sexual performance and libido. These compositions also boost stamina, endurance, strength, and mood.

Fenugreek may be provided to compositions in accordance with the present invention via Testofen®, a fenugreek extract that has been shown to increase testosterone. Preferably, all components of the fenugreek plant are included-stems, leaves, roots, etc. In addition to boosting testosterone, fenugreek has also been used to lower blood sugar, improve sexual performance, promote weight loss and improve overall mood. Fenugreek extracts are known to include numerous bioactive compounds, including flavonoids, alkaloids, coumarins, vitamins, and saponins; the most prevalent alkaloid is trigonelline and coumarins include cinnamic acid and scopoletin.

Table 1 shows an exemplary formulation of fenugreek and other active ingredients for inclusion in a composition in accordance with principles of the invention.

TABLE I
Primary Bioactive ingredients of Fenugreek Composition

| | | Exemplary |
|---|---|---|
| Ingredient | Range (mg) | Amount (mg) |
| Niacin | 5-150 | 30 |
| Pyridoxine HCL | 0.2-8.5 | 1.7 |
| Methylcobalamin | 0.0001 to 0.024 | .0024 |
| L-Citrulline | 250-4000 | 1000 |
| L-Arginine | 250-4000 | 1000 |
| Fenugreek | 25-1000 | 300 |
| Maca Root | 25-1000 | 250 |
| Panax Ginseng | 25-1000 | 250 |
| Caffeine | 50-300 | 180 |
| Magnesium (from Citrate) | 30-450 | 150 |
| Mucuna Pruriens (>95% L-DOPA) | 25-250 | 100 |
| γ-Aminobutyric Acid (GABA) | 25-500 | 100 |
| Zinc (from Citrate) | 5-200 | 88 |
| Vitamin D | 0.001-0.025 | .0025 |
| Ashwagandha | 100-1500 | 500 |

The niacin, vitamin B₃, may be in the form of nicotinic acid or niacinamide. Niacinamide may be preferable in some instances because it does not produce flushing. Pyridoxine HCl is a soluble form of vitamin B₆, required for amino acid synthesis. Methylcobalamin is a vitamer of B₁₂, which is also important for protein synthesis. L-citrulline and l-arginine are amino acids associated with building muscle protein. L-citrulline also boosts nitric oxide production. The 1-citrulline may be include citrulline malate and aspartate. L-arginine may be supplied in most any form, such as α-keto-glutarate or as a chloride. Maca Root, also known as “Peruvian ginseng” (but not related to actual ginseng) has been used to boost energy mood, and libido. Panax ginseng, also known as Korean ginseng, improves the body's resistance to stressors, and has been used to improve mood and cognitive ability. Caffeine is a well-known stimulant that provides a variety of benefits. Magnesium is provided in its citrate form, but may also be provided as a lactate, gluconate, malate, orotate, glycinate, ascorbate and/or aspartate. Magnesium oxide may also optionally be used, but because the oxide form generally has less bioavailability, it's organic forms are generally preferred. Mucuna pruriens, or Fabaceae, has been used to treat nervous disorders, male infertility and as an aphrodisiac. γ-Aminobutyric acid, or “GABA,” has been shown to have relaxing, anti-anxiety effects and is known to bind to a wide variety of ligands. Zinc is provided in the form of zinc citrate, but may also be included as an acetate, gluconate, oxide, or chelated with an amino acid such as for example aspartic acid, glutamic acid, cystine and histidine. Vitamin D is associated with normal function of the immune system, muscular system and immune responses, and also promotes bone health. Ashwagandha has been used to provide a variety of benefits including as a treatment for insomnia, aging, anxiety, physical and mental stress. It also may help lowering blood pressure and boosting the immune system. Fenugreek is the primary bioactive ingredient, and other exemplary embodiments may include additional bioactive ingredients, or may exclude one or more ingredients listed above. For example, in an alternative embodiment, Ashwagandha is not included as a bioactive ingredient.

Many of the bioactive ingredients of Table I, particularly fenugreek, have a very bitter, unpleasant taste. While several masking agents are known in the art for use in masking unpleasant flavors and smells, none have proven particularly effective in masking fenugreek. As a result, fenugreek is often consumed in the form of a pill, capsule or tablet.

In accordance with the principles of the invention, a unique mixture of masking agents are used to effectively suppress the unpleasant flavor and aroma of fenugreek, as well as the bitter tastes of some of the other bioactive ingredients shown in TABLE I above. The flavor system of the present invention which effectively masks the flavors of the bioactive ingredients is shown in TABLE II.

TABLE II
Flavor System Ingredients

| | | Exemplary |
|---|---|---|
| Ingredient | Range (mg) | Amount (mg) |
| Citric Acid | 100-3000 | 2000 |
| Malic Acid | 100-3000 | 1000 |
| Natural Flavors | 150-1500 | 700 |
| Sucralose | 25-500 | 150 |
| Powdered Vinnegar | 100-5000 | 2000 |
| Disodium Phosphate | 50-1000 | 400 |
| Potasssium Phosphate | 50-1000 | 400 |
| Sodium Gluconate | 50-1000 | 200 |
| Glycyrrhizzic Acid | 5-125 | 60 |
| Ginger Powder (as masking agent) | 5-125 | 25 |
| Vanilla (as a masking agent) | 10-300 | 100 |
| Orange (as a masking agent) | 10-300 | 50 |

Citric acid and malic acid both provide a sharp, tart taste and are both found in many citrus fruits. In addition, they both contribute to the citrate-malate shuttle that transports Coenzyme A in the mitochondria. Citric acid may also assist in dissolving and maintaining dissolution of the bioactive ingredients magnesium and zinc. Sucralose is an artificial sweetener that does not affect insulin levels in the blood. Powdered vinegar contributes to the sour flavor imparted by citric and malic acids. Disodium phosphate attenuates pH and has anti-coagulating properties which, without being bound by theory, the inventors believe interacts with the other ingredients of the composition to mask the bitter flavor of fenugreek. Sodium gluconate disassociates to provide gluconic acid in aqueous solution. Without being bound by theory, the inventors believe that gluconic acid acts as a chelating agent for the various bioactive ingredients, thereby contributing to the masking of the undesirable flavors.

Glycyrrhizzic acid is the primary sweet tasting constituents found in licorice, and is known to have a strong aroma and flavor. However, in the formulations in accordance with the present invention, glycyrrhizzic acid substantially counteracts the strong flavor of fenugreek. Without being bound by theory, the inventors believe this components works synergistically with other ingredients, acting as an emulsifier which directly reduces emission of undesirable aromas and/or acts as a type of sequestering compound for the components of fenugreek. Again, without being bound by theory, the inventors believe that the regions of the glycyrrizin and fenugreek responsible for their strong flavors interact such as for example by dimerizing or binding in a manner that reduces the strengths of their respective flavors. Glycrhizzic powder may optionally be provided using licorice powder in a range of 5-100 mg. Ginger, vanilla and orange are all well known masking agents which the inventors believe contribute to providing a pleasing flavor to the composition. The amounts of these four ingredients may vary depending on the amounts of the various active ingredients are used. Additional sweeteners may also be used to adjust flavoring as preferred for a particular composition.

The composition of the invention optionally includes various other ingredients shown in TABLE III.

TABLE III
Optional Additional Ingredients

| | | Exemplary |
|---|---|---|
| Ingredient | Range (mg) | Amount (mg) |
| Longjack or Tongkat Ali | 50-1000 | 200 |
| Diindolylmethane | 25-500 | 100 |
| Horny Goat Weed | 50-1000 | 200 |

Longjack or Tongkat Ali has long been used in Asian traditional medicine to treat a wide variety of ailments and as an aphrodisiac. More recently, certain extracts of Tongkat Ali have used to treat infertility. A phytonutrient and plant indole found in cruciferous vegetables including broccoli, brussels sprouts, cabbage, cauliflower and kale, with potential antiandrogenic and antineoplastic activities. Diindolymymethane, as a dimer of indole-3-carbinol, diindolylmethane (DIM) promotes beneficial estrogen metabolism in both sexes by reducing the levels of 16-hydroxy estrogen metabolites and increasing the formation of 2-hydroxy estrogen metabolites, resulting in increased antioxidant activity. Horny Goat Weed, or epimedium, has also been used in Asian traditional medicines, and is considered an aphrodisiac and a promoter of sexual health. In addition to the ingredients listed in TABLE III, cocoa may also be used as a flavoring agent. Cocoa may be provided via cocoa powder or any other suitable form.

Compositions in accordance with the principles of the invention include the bioactive ingredients shown in TABLE I and the Flavoring System of the invention shown in TABLE II. Some or all of the ingredients of the mixture may be prepared as a powder to be added to water to form an aqueous mixture. While the composition is generally intended to be consumed in an aqueous mixture, which may be carbonated, those skilled in the art will appreciate that storing the composition is a dry powder may increase its shelf life. It is contemplated that the composition in accordance with principles of the invention make a combined with the optional ingredients stated herein, or with other desired ingredients. It may also optionally be used in cooking to prepare solid foods.

To prepare an aqueous mixture, about 4-10 mg of the composition is added to water. Optionally, the aqueous mixture may be carbonated. The aqueous mixture may be prepared an an energy drink, and therefore may optionally include additional sugar and flavoring. Optionally, the composition may be dried to create a powdered drink mix that may be added to water or carbonated water. Those skilled in the art will appreciate that there are a variety of drying methods, which may use heating and/or dessicating methods to prepare a powder for use as a drink mix.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. Descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. A nutritional supplement composition comprising:
5-150 mg of niacin;
0.2-8.5 mg of pyridoxine HCL;
0.0001-0.024 mg of methylcobalamin;
250-4000 mg of 1-citrulline;
250-4000 mg of 1-arginine;
25-1000 mg of fenugreek extract;
25-1000 mg of maca root extract;
25-1000 mg of panax ginseng;
50-300 mg of caffeine;
30-450 mg of magnesium;
25-250 mg of a Mucuna pruriens extract comprising at least 95% L-DOPA;
25-500 mg of γ-aminobutyric acid;
5-200 mg of zinc;
0.001-0.25 mg of vitamin D;
100-1500 mg of ashwagandha extract; and,
a flavor masking agent, wherein the flavor masking agent comprises 5-125 mg glycyrrhizzic acid.

2. The nutritional supplement composition of claim 1 wherein the flavor masking agent further comprises:
100-3000 mg of citric acid;
100-3000 mg of malic acid;
25-500 mg of sucralose;
100-5000 mg of powdered vinegar;
50-1000 mg of disodium phosphate;
50-1000 mg of potassium phosphate;
50-1000 mg of sodium gluconate;
5-125 mg of ginger powder;
10-300 mg of vanilla extract; and,
10-300 mg of orange extract.

3. The nutritional supplement composition of claim 2 wherein the fenugreek is a whole fenugreek plant extract.

4. The nutritional supplement composition of claim 3 wherein the composition comprises:
30 mg of niacin;
1.7 mg of pyridoxine HCL;
0.0024 mg of methylcobalamin;
1000 mg of 1-citrulline;
1000 mg of 1-arginine;
300 mg of fenugreek whole plant extract;
250 mg of maca root extract;
250 mg of panax ginseng extract;
180 mg of caffeine;
150 mg of magnesium;
100 mg of a Mucuna pruriens extract comprising at least 95% L-DOPA;
100 mg of γ-aminobutyric acid;
88 mg of zinc;
0.0025 mg of vitamin D; and,
500 mg of ashwagandha extract.

5. The nutritional supplement composition of claim 4 wherein the masking agent comprises:
60 mg glycyrrhizic acid;
2000 mg of citric acid;
1000 mg of malic acid;
150 mg of sucralose;
2000 mg of powdered vinegar;
400 mg of disodium phosphate;
400 mg of potassium phosphate;
200 mg of sodium gluconate;
25 mg of ginger powder;
100 mg of vanilla extract; and,
50 mg of orange extract.

6. The nutritional supplement composition of claim 5 further comprising:
50-1000 mg of tongkat ali extract;
25-500 mg of diindolylmethane; and
50-1000 mg of horny goat weed extract.

7. The nutritional supplement composition of claim 5 comprising;
200 mg of tongkat ali extract;
100 mg of diindolylmethane; and,
200 mg of horny goat weed extract.

8. The nutritional supplement composition of claim 7 wherein the composition is in the form of an aqueous mixture comprising 5-10 grams of the nutritional supplement composition per 12 ounces of water.

9. The nutritional supplement composition of claim 8 wherein the aqueous mixture is carbonated.

10. The nutritional supplement composition of claim 9 wherein the aqueous mixture comprises 7-8 mg of the nutritional supplement composition per 12 ounces of water.

11. The nutritional supplement composition of claim 7 wherein the composition is dried to form a powder capable of being dissolved in an aqueous solution.
